(19) United States
(12) Patent Application Publication
(10) Pub. No.: US 2006/0099018 A1
(43) Pub. Date: May 11, 2006

(54) Image capturing apparatus

(75) Inventors: Chin-Yuan Lin, Taichung City (TW); Yi-Kai Lin, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AVISION INC.

(21) Appl. No.: 11/224,826

(22) Filed: Sep. 13, 2005

(30) Foreign Application Priority Data
Nov. 5, 2004 (TW) 93133866

(51) Int. Cl. G03G 15/00

(52) U.S. Cl. 399/370

(57) ABSTRACT

An image capturing apparatus for capturing images of a document includes a scan module, a control unit and a document feeder. The scan module is for scanning the document while the document feeder is for feeding the document to the scan module. The document feeder includes a paper tray, a sheet feeding mechanism, and a roller set. The paper tray is for storing the document, the sheet feeding mechanism is for moving the document, and the roller set is disposed on the paper tray. When the document is fed from the paper tray by the sheet feeding mechanism, the control unit determines a size of the document according to the rotating status of the roller set.

This application claims the benefit of Taiwan application Serial No. 93133866, filed Nov. 5, 2004, the subject matter of which is incorporated herein by reference.

### BACKGROUND OF THE INVENTION

1. Field of the Invention

The invention relates in general to an image capturing apparatus, and more particularly to an image capturing apparatus with a document feeder, which can determine the size of the document and particularly distinguish between an A4-sized sheet and an A3-sized sheet in advance.

2. Description of the Related Art

FIG. 1A is a schematic block diagram of a conventional scan apparatus having a document feeder. Referring to FIG. 1A, the scan apparatus 100 includes a document feeder 110, a scan module 130, and a control unit 140. The document feeder 110, controlled by the control unit 140, is for feeding the document 111. After the document 111 is fed in, the scan module 130 scans the document 111 and sends the corresponding scan images to the control unit 140 for further image processing.

Generally, the document feeder 110 includes a paper tray 112, a paper guider 114 and a sensing device 150. The paper tray 112 is for placing the document 111, and the paper guider 114 is for aligning the document 111 in one single direction and thus preventing a paper jam. The sensing device 150 detects the width of the document 111 as the document 111 is placed on the paper tray 112, and detects the trailing edge to determine the length and the size of the document 111, such as A3 or A4, after the document feeder 110 feeds in the document 111. However, when the document 111 is an A4 sheet in landscape orientation, the document 111 is very easily to be erroneously determined as an A3 sheet in portrait orientation, thereby affecting the subsequent scan process, since the length of the A4 sheet is just equal to the width of the A3 sheet. Furthermore, the control unit 140 can calculate the actual size of the document 111 only after the document 111 is fed in and is scanned by the scan module 130. As a result, the A4-sized document 111 in landscape orientation will be determined as an A3-sized document and the control unit 140 would use the data for subsequent scan and image processing; thereby resulting in poor image quality.

In order to perform scan and image-processing procedures effectively and quickly, the best way is to determine the size of the document 111 when the document 11 is placed on the paper tray. Referring to FIG. 1B, a partial cross-sectional view of a document feeder disclosed in U.S. Pat. No. b 6,151,478 is shown. The document feeder 160 includes a paper tray 162, a feeding roller 164, a set of the first sensors 166 and a set of the second sensors 168. The first sensors 166 are disposed on the paper tray 162, while the second sensors are disposed at a position behind the feeding roller 164. When the document 161 is placed on the paper tray 162, the first sensors 166 detect the length of the document 161, and when the document 161 is fed into the scan apparatus by the feeding roller 164, the second sensors 168 detect the width of the document 161. Although the first sensors 166 are mounted on the paper tray 152 and capable of detecting the length of the document 161, when the A4-sized document in landscape orientation and the A3-sized document in portrait orientation are stacked on the paper tray 162, this prior art still cannot identify the A4-sized document 161. In addition, the second sensors 168 can only detect the width of the document 161, and thus apparently cannot distinguish the A4-sized document in landscape orientation from the A3-sized document in portrait orientation.

### SUMMARY OF THE INVENTION

It is therefore an object of the invention to provide an image capturing apparatus. By the design of a roller set disposed on the paper tray, the image capturing apparatus can determine the size of a document stored in the paper tray and further distinguish between an A3-sized document in portrait orientation or an A4-sized document in landscape orientation by detecting if the document rotates the roller set or the duration for which the document rotates the roller set, and uses the result for further scan and image-processing procedures.

The invention achieves the above-identified object by providing an image capturing apparatus for capturing images of a document. The image capturing apparatus includes a scan module, a control unit, and a document feeder. The scan module is for scanning the document. The document feeder is for feeding in the document, such that the document is scanned by the scan module. The document feeder includes a paper tray, a sheet feeding mechanism and a roller set. The paper tray is for storing the document, the sheet feeding mechanism is for moving the document, and the roller set is disposed on the paper tray. The control unit is electrically connected to the scan module and the document feeder. When the document is fed from the paper tray by the sheet feeding mechanism, the control unit determines a size of the document according to the rotating status of the roller set.

The invention achieves the above-identified object by providing a document feeder applied in an image capturing apparatus. The document feeder includes a paper tray, a sheet feeding mechanism, and a roller set. The paper tray is for storing the document. The sheet feeding mechanism is for moving the document. The roller set is disposed on the paper tray. When the document is fed from the paper tray by the sheet feeding mechanism, the roller set is rotated by the document or not. The size of the document can be accordingly determined.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a schematic block diagram of a conventional scan apparatus having a document feeder.

FIG. 1 B (Prior Art) is a partially cross-sectional view of a document feeder disclosed in U.S. Pat. No. 6,151,478.

FIG. 2A is a schematic block diagram of an image capturing apparatus according to a preferred embodiment of the invention.

FIG. 2B is a vertical view of the image capturing apparatus with the roller set disposed on the paper guider according to the preferred embodiment of the invention.

FIG. 2C is a vertical view of the image capturing apparatus with the roller set disposed in the paper tray within the compass of the A4-sized sheet placed in landscape orientation according to the preferred embodiment of the invention.

FIG. 2D is a vertical view of the image capturing apparatus with the roller set disposed above the paper tray within the compass of the A3-sized sheet placed in portrait orientation and outside the compass of the A4-sized sheet placed in landscape orientation according to the preferred embodiment of the invention.

FIG. 2E is a vertical view of the image capturing apparatus with the roller set disposed in the paper tray within the compass of the A3-sized sheet placed in portrait orientation and outside the compass of the A4-sized sheet placed in landscape orientation according to the preferred embodiment of the invention.

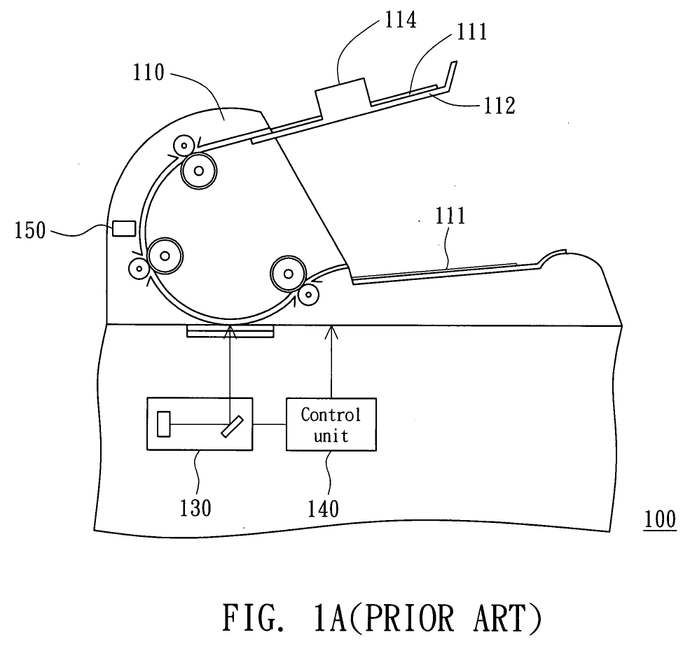

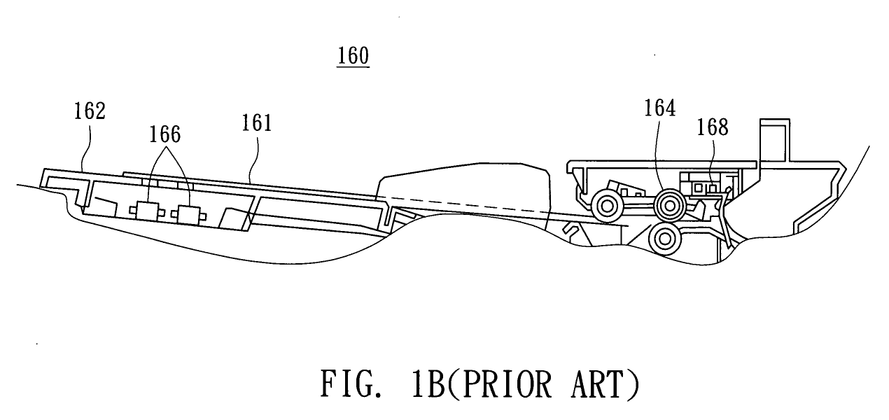

### DETAILED DESCRIPTION OF THE INVENTION

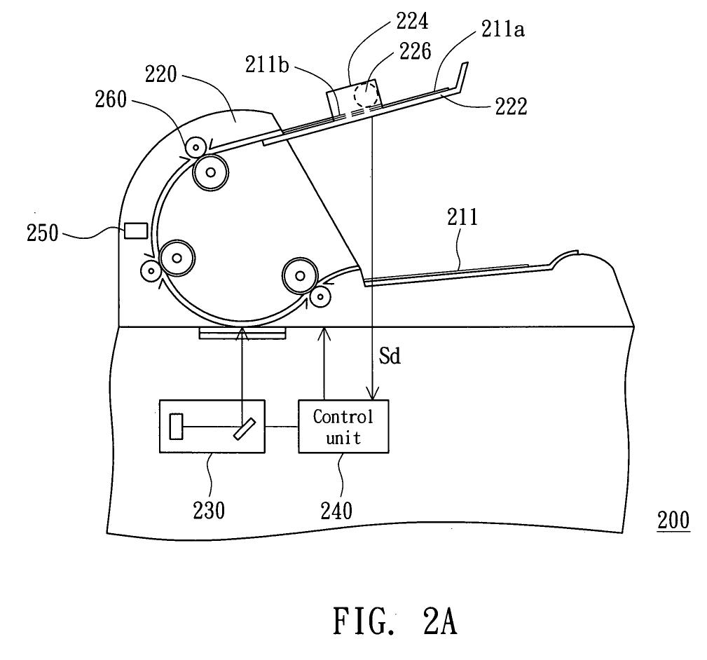

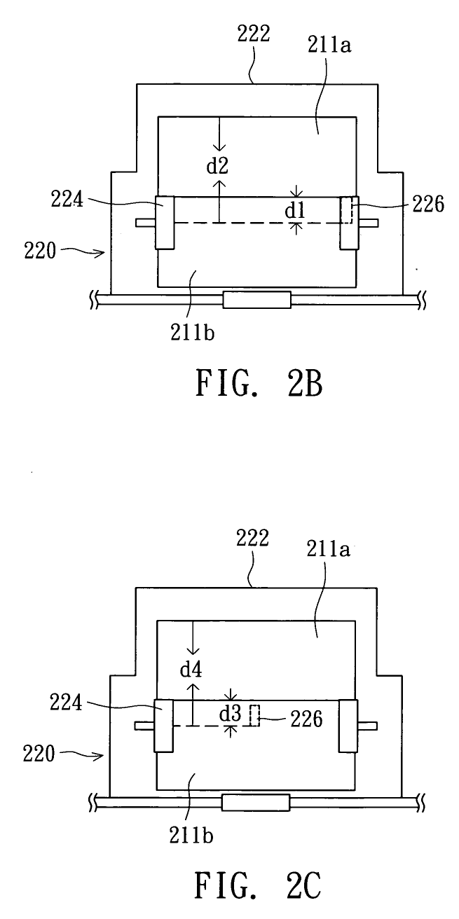

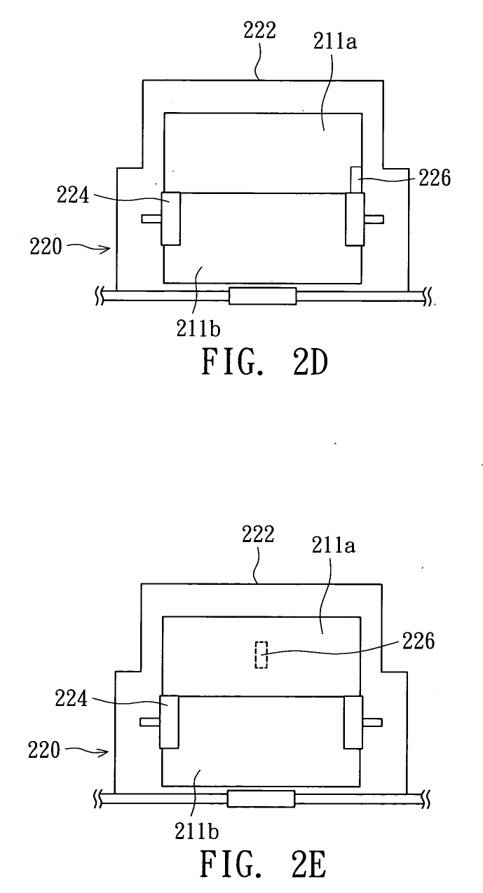

Referring to FIG. 2A, a schematic block diagram of an image capturing apparatus according to a preferred embodiment of the invention is shown. The image capturing apparatus 200 is used for capturing images of a document 211, which may consist of one single sheet, sheets of one size, or sheets of different sizes, such as A3 and A4. Here, the document 211 consists of an A3-sized sheet 211a and an A4-sized sheet 211b. The image capturing apparatus 200 includes a document feeder 220, a scan module 230 and a control unit 240. The scan module 230 is for scanning the document 211 and the control unit 240 is electrically connected to the scan module 230. The document feeder 220 is for feeding in the document 211. The document feeder 220, such as an automatic document feeder (ADF), includes a paper tray 222, a paper guider 224, a sensing device 250, a sheet feeding mechanism 260, and a roller set 226. The paper tray 222 is for storing the document 211 while the paper guider 224 is for aligning the document 211. The sensing device 250 detects the width of the document 211. The sheet feeding mechanism moves the document 211. The roller set 226 is disposed on the paper tray 222. The control unit 240 is electrically connected to the scan module 230 and the document feeder 220.

As shown in FIG. 2B, when the A3-sized sheet 211a in portrait orientation and the A4-sized sheet 211b in landscape orientation are stacked on the paper tray 222, the sensing device 250 will detect the sizes of the two sheets 211a and 211b which have the same width, thereby easily mistaking the A4-sized sheet 211b in landscape orientation for the A3-sized sheet 211a in portrait orientation. Therefore, according to the embodiment of the invention, when the document feeder 220 feeds the document 211 into the apparatus 200, the control unit 240 can thus determine the sizes of the A3-sized sheet 211a and the A4-sized sheet 211b according to the rotating status of the roller set 226.

As shown in FIG. 2B, the roller set 226 is disposed on the paper guider 224 within the compass of the A4-sized sheet 211b and the A3-sized sheet 211a on the paper tray 222 and can touch the surface of the document 211. When the document feeder 220 feeds the document 211 in from the paper tray 222, the document 211 rotates the roller set 226 by friction. Since the distance d1 by which the A4-sized sheet 211b slides past the roller set 226 is shorter than the distance d2 by which the A3-sized sheet 211a slides past the roller set 226, the duration (or number of times which the roller set 226 rotates) for which the A4-sized sheet 211b rotates the roller set 226 is shorter than the duration for which the A3-sized sheet 211a rotates the roller set 226.

Consequently, the control unit 240 can determine the sizes of the A3-sized sheet 211a and the A4-sized sheet 211b according to the determination signal Sd output from the roller set 226, i.e. the rolling time (or number of rotations) of the roller set 226. The control unit 240 can accordingly control the scan module 230 to perform scan operation.

The above-mentioned roller set 226 can also be disposed anywhere in the paper tray 222 within the compass of the A4-sized sheet 211b, as shown in FIG. 2C. When the sheets 211a and 211b are one by one fed into the document feeder 220, the A3-size sheet 211a and the A4-sized sheet 211b both rotate the roller set 226. The distance d3 by which the A4-sized sheet 211b slides past the roller set 226 is smaller than the distance d4 by which the A3-sized sheet 211a slides past the roller set 226. Therefore, the duration (or number of rotations of the roller set) for which the A4-sized sheet 211b rotates the roller set 226 is less than the duration for which the A3-sized sheet 211a does. Similarly, the control unit 240 can determine the size of A3-sized sheet 211a and the A4-sized sheet 211b before the document 211 is being scanned.

Moreover, as shown in FIGS. 2D and 2E, the above-mentioned roller set 226 can also be disposed on the paper tray 222 within the compass of the A3-sized sheet 211a and outside the compass of the A4-sized sheet 211b. When the A3-sized sheet 211a in portrait orientation is being fed into the document feeder 220, the roller set 226 can touch the surface of the A3-sized sheet 211a, and thus the A3-sized sheet 211a can rotate the roller set 226 by friction. In contrast, when the A4-sized sheet 211b is being fed into the document feeder 220, because the roller set 226 is located at a position outside the A4-sized sheet 211b, the A4-sized sheet 211b will not rotate the roller set 226. Therefore, the control unit 240 can determine the sizes of the A3-sized sheet 211a and the A4-sized sheet 211b according to whether the roller set 226 rotates or not, in advance.

The image capturing apparatus disclosed by the embodiment of the invention has the following advantages. With the simple roller structure disposed on the paper tray, the size of a document can be determined beforehand according to the rolling status of the roller, such that the image of the document will be generated in better quality.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image capturing apparatus, for capturing images of a document, the image capturing apparatus comprising:
a scan module, for scanning the document;
a document feeder, for feeding the document to the scan module, the document feeder comprising:
a paper tray, for storing the document;
a sheet feeding mechanism for moving the document; and
a roller set, disposed on the paper tray; and
a control unit, electrically connected to the scan module and the document feeder; and
wherein when the document is fed from the paper tray by the sheet feeding mechanism, the control unit determines a size of the document according to the rotating status of the roller set.

2. The image capturing apparatus according to claim 1, wherein the roller set is driven to rotate by the document when the document moves.

3. The image capturing apparatus according to claim 2, wherein the control unit determines a length of the document according to rotating time of the roller set, wherein the length of the document is directly proportional to the rotating time.

4. The image capturing apparatus according to claim 2, wherein the document feeder further comprises a paper guider for aligning the document, and the roller set is disposed on the paper guider.

5. The image capturing apparatus according to claim 1, wherein the roller set is not driven to rotate by the document when the document moves.

6. The image capturing apparatus according to claim 5, wherein the control unit determines that the document is shorter than a first length.

7. The image capturing apparatus according to claim 1, wherein the document feeder is an automatic document feeder (ADF).

8. The image capturing apparatus according to claim 1, wherein the document comprises a first sheet and a second sheet of two different sizes, wherein a width of the first sheet is the same as that of the second sheet.

9. The image capturing apparatus according to claim 8, wherein the roller set is disposed within the compass of the first sheet and outside the second sheet, the control unit determines the size of each of the first sheet and the second sheet according to whether or not the roller set rotates.

10. The image capturing apparatus according to claim 8, wherein the first sheet is an A3-sized sheet, and the second sheet is an A4-sized sheet.

11. A document feeder, applied in an image capturing apparatus, for feeding a document, the document feeder comprising:
a paper tray for storing the document;
a sheet feeding mechanism for moving the document; and
a roller set, disposed on the paper tray;
wherein when the document is fed from the paper tray by the sheet feeding mechanism, the image capturing apparatus determines a size of the document according to the rotating status of the roller set.

12. The document feeder according to claim 11, wherein the roller set is driven to rotate by the document when the document moves.

13. The document feeder according to claim 12, wherein the image capturing apparatus determines a length of the document according to rotating time of the roller set, wherein the length of the document is directly proportional to the rotating time.

14. The document feeder according to claim 12, wherein the document feeder further comprises a paper guider for aligning the document, and the roller set is disposed on the paper guider.

15. The document feeder according to claim 11, wherein the roller set is not driven to rotate by the document when the document moves.

16. The document feeder according to claim 15, wherein the image capturing apparatus determines that the document is shorter than a first length.

17. The document feeder according to claim 11, wherein the document feeder is an automatic document feeder (ADF).

18. The document feeder according to claim 11, wherein the document comprises a first sheet and a second sheet of two different sizes, wherein a width of the first sheet is the same as that of the second sheet.

19. The document feeder according to claim 18, wherein the roller set is disposed within the compass of the first sheet and outside the second sheet, the image capturing apparatus determines the size of each of the first sheet and the second sheet according to whether or not the roller set rotates.

20. The document feeder according to claim 18, wherein the first sheet is an A3-sized sheet, and the second sheet is an A4-sized sheet.
